(19) United States
(12) Patent Application Publication
(10) Pub. No.: US 2010/0330405 A1
(43) Pub. Date: Dec. 30, 2010

(54) NONAQUEOUS ELECTROLYTE SECONDARY BATTERY

(76) Inventors: Masanori Sumihara, Osaka (JP); Masakazu Yamada, Osaka (JP); Tsutomu Nishioka, Osaka (JP)

Correspondence Address: MCDERMOTT WILL & EMERY LLP, 600 13TH STREET, NW, WASHINGTON, DC, 20005-3096, US

(21) Appl. No.: 12/866,391

(22) PCT Filed: Jun. 18, 2009
(86) PCT No.: PCT/JP2009/002769

§ 371 Date: Aug. 5, 2010

(30) Foreign Application Priority Data
Jun. 23, 2008 (JP) 2008-162909
Jun. 25, 2008 (JP) 2008-165564
Aug. 6, 2008 (JP) 2008-202818

(51) Int. Cl. H01M 10/0587

(52) U.S. Cl. 429/94

(57) ABSTRACT

[Purpose] A purpose of the present invention is to provide a nonaqueous electrolyte secondary battery with high safety in which breakage of a positive electrode plate and buckling of a negative electrode plate are reduced during charging and discharging.

[Solutions] A nonaqueous electrolyte secondary battery includes an electrode group 10 in which a positive electrode plate 4 including a positive electrode current collector 1 and a positive electrode material mixture layer 2a, 2b formed on the positive electrode current collector 1, and a negative electrode plate 8 including a negative electrode current collector 5 and a negative electrode material mixture layer 6a, 6b formed on the negative electrode current collector 8, are wound or stacked with a separator 9 interposed therebetween. The positive electrode material mixture layer 2a, 2b has at least one thin portion 3a, 3b extending perpendicularly to a longitudinal direction of the positive electrode plate 4.

### TECHNICAL FIELD

The present disclosure relates to nonaqueous electrolyte secondary batteries typified by lithium ions secondary batteries, and more particularly to a nonaqueous electrolyte secondary battery with high safety.

### BACKGROUND ART

Lithium ion secondary batteries, which have been widely used as power sources of mobile electronic equipment in recent years, use carbonaceous materials, for example, allowing insertion and extraction of lithium as active materials for negative electrode plates, and also use complex oxides of transition metals and lithium, such as LiCoO₂, as active materials for positive electrode plates, thereby achieving high potential and high discharge capacity. However, with a recent increase in the number of functions of electronic equipment and communication equipment, the capacity of lithium ion secondary batteries needs to be further increased.

Therefore, to increase the capacity of a lithium ion secondary battery, a positive electrode current collector and a negative electrode current collector are coated with active material layers, and then dried, and the resultant structure is compressed by, for example, pressing to a predetermined thickness. With this technique, the active material density is increased, thereby further increasing the capacity.

A nonaqueous electrolyte secondary battery is fabricated by housing, in a battery case, an electrode group formed by stacking or winding a positive electrode plate and a negative electrode plate with a porous insulating layer interposed therebetween, then pouring a nonaqueous electrolyte into the battery case, and then sealing an opening of the battery case with a sealing plate.

With the increase in the capacity, serious consideration needs to be given to safety measures. In particular, when an internal short circuit occurs between the positive electrode plate and the negative electrode plate, a rapid temperature rise of the battery might occur. Therefore, safety enhancement of nonaqueous electrolyte secondary batteries is strongly demanded. Since a temperature rise is very rapid especially in large-size high-power nonaqueous electrolyte secondary batteries, these batteries need measures for safety improvement.

An internal short circuit of a nonaqueous electrolyte secondary battery seems to be caused by breakage or buckling of electrode plates as well as contamination of foreign substances in the battery. Specifically, as illustrated in FIG. 16A, the breakage or buckling of electrode plates is caused by a stress applied to the electrode plates while an electrode group 30 is formed by winding a positive electrode plate 24 in which positive electrode material mixture layers 22a and 22b are formed on both surfaces of a positive electrode current collector 21 and a negative electrode plate 28 in which negative electrode mixture layers 26a and 26b are formed on both surfaces of a negative electrode current collector 25 with a porous insulating layer 29 interposed therebetween or while the nonaqueous electrolyte secondary battery is charged or discharged.

More specifically, in winding the electrode plates in a spiral to form the electrode group 30, a tensile stress is applied to the positive electrode plate 24, the negative electrode plate 28, and the porous insulating layer 29. At this time, one of these components exhibiting the lowest degree of extension is broken first. In addition, while the nonaqueous electrolyte secondary battery is charged and discharged, a stress induced by expansion and contraction of the electrode plates is applied to the electrode plates, and repetitive charging and discharging of the battery causes one of the components of the battery exhibiting the lowest degree of extension to be broken first.

For example, as illustrated in FIG. 16B, if the positive electrode plate 24 cannot follow extension of the negative electrode plate 28 during charging, the positive electrode plate 24 is broken (indicated by F in the drawing). Even if the positive electrode plate 24 is not broken, the negative electrode plate 28 buckles as illustrated in FIG. 16C, and the porous insulating layer 29 is extended, thereby forming a portion (indicated by G in the drawing) where the porous insulating layer 29 is thin.

Further, if the positive electrode plate 24 or the negative electrode plate 28 is broken before the porous insulating layer 29 is broken, the broken portion of the electrode plate penetrates the porous insulating layer 29, thereby causing a short circuit between the positive electrode plate 24 and the negative electrode plate 28. This short circuit causes large current to flow, resulting in that the temperature of the nonaqueous electrolyte secondary battery might increase rapidly.

To reduce breakage of the positive electrode plate, Patent Document 1 describes the following technique. Specifically, as illustrated in FIG. 17, in a nonaqueous electrolyte secondary battery 31 in which a flat electrode group 32 formed by winding a positive electrode plate 33 whose both surfaces are coated with positive electrode material mixture layers and a negative electrode plate 34 whose both surfaces are coated with negative electrode material mixture layers with a porous insulating layer 35 interposed therebetween is housed in a battery case 36 together with a nonaqueous electrolyte, the positive electrode material mixture layer formed on the inner surface of the electrode group 32 has a flexibility (i.e., elongation at break) higher than that of the positive electrode material mixture layer formed on the outer surface thereof.

### CITATION LIST

### Patent Document

PATENT DOCUMENT 1: Japanese Patent Publication No. 2007-103263

### SUMMARY OF THE INVENTION

### Technical Problem

With the foregoing technique, however, although breakage of the positive electrode plate caused by a bending stress applied to the positive electrode plate in forming the electrode group is reduced, it is still difficult to reduce breakage or buckling of the electrode plate caused by a stress due to expansion and contraction of the electrode plate during charging and discharging of the nonaqueous electrolyte secondary battery. In addition, in the technique, two types of the positive electrode material mixture slurry need to be respectively prepared for the front and back surfaces of the positive electrode plate and to be applied onto the positive electrode current collector. Accordingly, the process of fabricating the positive electrode plate is complicated.

It is therefore a main object of the present invention to provide a nonaqueous electrolyte secondary battery with high safety in which breakage of a positive electrode plate or buckling of a negative electrode plate occurring during charging and discharging is reduced by reducing a stress induced by expansion and contraction of the negative electrode plate during charging and discharging of the nonaqueous electrolyte secondary battery.

### Solution to the Problem

To achieve the object, the present invention employs a configuration in which the degree of extension of the positive electrode plate is increased so as to follow expansion and contraction of the negative electrode plate during charging and discharging such that the degrees of expansion and contraction of the positive electrode plate and the negative electrode plate match each other during charging and discharging.

Specifically, a nonaqueous electrolyte secondary battery in an aspect of the present invention includes an electrode group in which a positive electrode plate including a positive electrode current collector and a positive electrode material mixture layer formed on the positive electrode current collector, and a negative electrode plate including a negative electrode current collector and a negative electrode material mixture layer formed on the negative electrode current collector, are wound or stacked with a separator interposed therebetween, wherein the positive electrode material mixture layer has at least one thin portion extending perpendicularly to a longitudinal direction of the positive electrode plate.

With this configuration, the degrees of expansion and contraction of the positive electrode plate and the negative electrode plate match each other during charging and discharging. Accordingly, a stress due to a difference in the degree of expansion and contraction between the positive electrode plate and the negative electrode plate during charging and discharging can be reduced, resulting in reducing breakage or buckling of the electrode plates.

In another aspect of the present invention, the thin portion of the positive electrode material mixture layer is preferably located on at least an inner surface of the positive electrode current collector.

In another aspect of the present invention, the thin portion of the positive electrode material mixture layer is preferably located on each surface of the positive electrode current collector, and the thin portion located on an inner surface of the positive electrode current collector and the thin portion located on an outer surface of the positive electrode current collector preferably have phases which are shifted from each other.

In another aspect of the present invention, the thin portion of the positive electrode material mixture layer is preferably located on each surface of the positive electrode current collector, and the thin portion located on an inner surface of the positive electrode current collector preferably has a width lager than a width of the thin portion located on an outer surface of the positive electrode current collector. The positive electrode material mixture layer may include multiple ones of the at least one thin portion, and widths of the thin portions may decrease from a winding center to a winding end of the electrode group.

In another aspect of the present invention, the positive electrode material mixture layer preferably includes multiple ones of the at least one thin portion, the positive electrode material mixture layer is preferably formed on each surface of the positive electrode current collector, and a distance between each adjacent ones of the thin portions located on an inner surface of the positive electrode current collector is smaller than a distance between each adjacent ones of the thin portions located on an outer surface of the positive electrode current collector. The positive electrode material mixture layer may include multiple ones of the at least one thin portion, and a distance between each adjacent ones of the thin portions may increase from a winding center to a winding end of the electrode group.

In another aspect of the present invention, the thin portion of the positive electrode material mixture layer is preferably located at least at a position where the positive electrode material mixture layer has a small radius of curvature near a winding center of the electrode group.

In another aspect of the present invention, instead of the thin portion, the positive electrode material mixture layer preferably has at least one low-density active material portion extending perpendicularly to the longitudinal direction of the positive electrode plate.

### ADVANTAGES OF THE INVENTION

According to the present invention, the degrees of expansion and contraction of the positive electrode plate and the negative electrode plate match each other during charging and discharging. Accordingly, a stress due to a difference in the degree of expansion and contraction between the positive electrode plate and the negative electrode plate during charging and discharging can be reduced, thereby reducing breakage or buckling of the electrode plates. As a result, a nonaqueous electrolyte secondary battery with high safety in which an internal short circuit due to the foregoing problems is reduced.

### BRIEF DESCRIPTION OF THE DRAWINGS

FIG. 1 is a partially cut-away perspective view illustrating a configuration of a lithium ion secondary battery according to a first embodiment of the present invention.

FIGS. 2A-2C are cross-sectional views partially illustrating a configuration of an electrode group of the first embodiment.

FIGS. 3A and 3B are perspective views partially illustrating a configuration of the electrode group before winding in the first embodiment.

FIG. 4 is a perspective view partially illustrating another configuration of the electrode group before winding in the first embodiment.

FIG. 5 is a perspective view partially illustrating another configuration of the electrode group before winding in the first embodiment.

FIG. 6 is a perspective view partially illustrating another configuration of the electrode group before winding in the first embodiment.

FIG. 7 is a perspective view partially illustrating another configuration of the electrode group before winding in the first embodiment.

FIG. 8 is a perspective view partially illustrating another configuration of the electrode group before winding in the first embodiment.

FIG. 9 is a perspective view partially illustrating another configuration of the electrode group before winding in the first embodiment.

FIGS. 10A and 10B are perspective views showing a method for forming a positive electrode plate according to a second embodiment of the present invention.

FIG. 11 is a perspective view partially illustrating a configuration of the positive electrode plate of the second embodiment.

FIG. 12 is a perspective view partially illustrating another configuration of the positive electrode plate of the second embodiment.

FIG. 13 is a perspective view partially illustrating another configuration of the positive electrode plate of the second embodiment.

FIG. 14 is a perspective view partially illustrating another configuration of the positive electrode plate of the second embodiment.

FIG. 15 is a perspective view partially illustrating another configuration of the positive electrode plate of the second embodiment.

FIGS. 16A-16C are cross-sectional views illustrating a configuration of an electrode group for describing factors of an internal short circuit.

FIG. 17 is a cross-sectional view illustrating a configuration of a conventional nonaqueous electrolyte secondary battery.

### DESCRIPTION OF EMBODIMENTS

Embodiments of the present invention will be described in detail hereinafter with reference to the drawings. It should be noted that the present invention is not limited to the following embodiments. Various changes and modifications may be made without departing from the scope of the present invention, and the following embodiments may be combined as necessary.

### First Embodiment

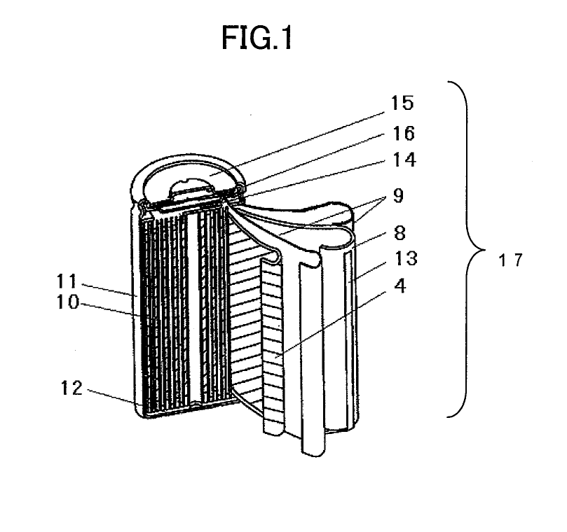

FIG. 1 is a partially cut-away perspective view illustrating a configuration of a lithium ion secondary battery according to a first embodiment of the present invention.

As illustrated in FIG. 1, an electrode group 10 is formed by winding, in a spiral, a positive electrode plate 4 using a composite lithium oxide as an active material and a negative electrode plate 8 using a material capable of holding lithium as an active material, with a porous insulating layer (i.e., a separator) 9 interposed therebetween. The electrode group 10 is housed in a closed-end cylindrical battery case 11, while being insulated from the battery case 11 by an insulating plate 12. A negative electrode lead 13 extending from the bottom of the electrode group 10 is connected to the bottom of the battery case 11, whereas a positive electrode lead 14 extending from the top of the electrode group 10 is connected to a sealing plate 15. After a nonaqueous electrolyte (not shown) has been poured into the battery case 11, an opening of the battery case 11 is sealed with the sealing plate 15 with a gasket 16 sandwiched therebetween.

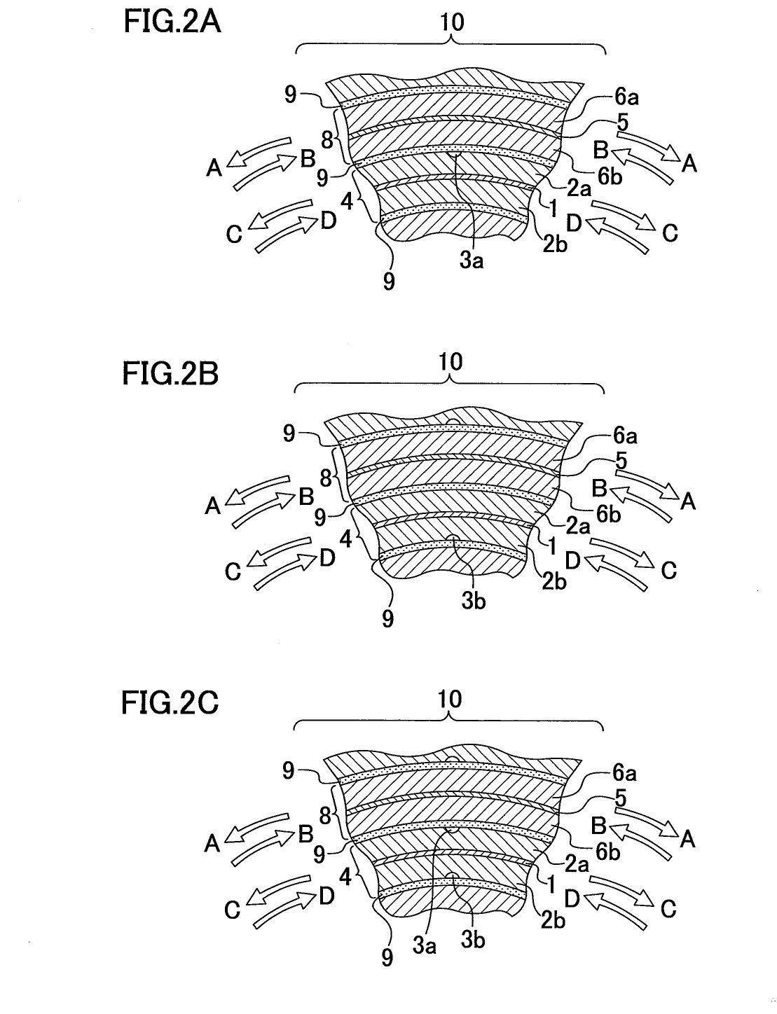

FIGS. 2A-2C are cross-sectional views partially illustrating the configuration of the electrode group 10 of this embodiment. The electrode group 10 is formed by winding the positive electrode plate 4 in which positive electrode material mixture layers 2a and 2b are respectively formed on both surfaces of a positive electrode current collector 1 and the negative electrode plate 8 in which negative electrode material mixture layers 6a and 6b are respectively formed on both surfaces of a negative electrode current collector 5 with the separator 9 interposed therebetween. The positive electrode material mixture layers 2a and 2b have at least one thin portion extending perpendicularly to the longitudinal direction of the positive electrode plate 4 (i.e., extending vertically to the drawing sheet). This thin portion only needs to be provided on at least one surface of the positive electrode current collector 1. FIG. 2A shows an example in which a thin portion 3a is provided on the outer surface (i.e., the surface facing the outside of the electrode group 10) of the positive electrode current collector 1. FIG. 2B shows an example in which a thin portion 3b is provided on the inner surface (i.e., the surface facing the inside of the electrode group 10) of the positive electrode current collector 1. FIG. 2C shows an example in which thin portions 3a and 3b are provided on both surfaces of the positive electrode current collector 1.

As illustrated in FIGS. 2A-2C, the positive electrode plate 4 and the negative electrode plate 8 expand in the directions indicated by arrows A and C during charging, and contract in the directions indicated by arrows B and D. However, the presence of the thin portions 3a and 3b in parts of the positive electrode material mixture layers 2a and 2b can increase the degree of expansion of the positive electrode plate 4, thereby matching the degree of expansion and contraction of the positive electrode plate 4 with those of the negative electrode plate 8 during charging and discharging. Consequently, a stress induced by a difference in the degree of expansion and contraction between the positive electrode plate 4 and the negative electrode plate 8 during charging and discharging can be reduced, resulting in reducing breakage or buckling of the electrode plates 4 and 8.

The number and the shape (e.g., thickness, width, and pitch) of the thin portions 3a and 3b provided in parts of the positive electrode material mixture layers 2a and 2b are not specifically limited, and may be determined according to the degree of extension of the negative electrode plate 8 to be used.

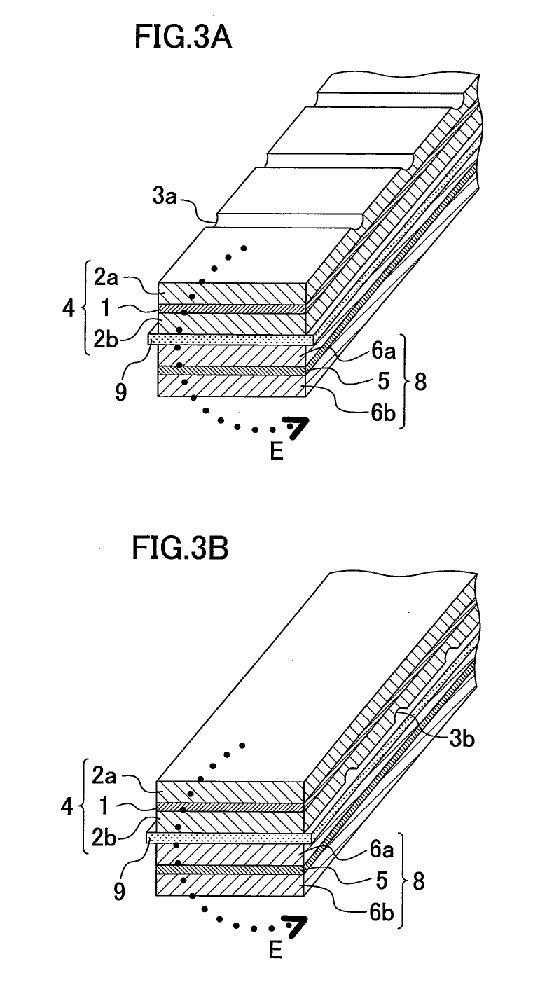

Referring now to FIGS. 3-9, various examples of the thin portions 3a and 3b provided in the positive electrode material mixture layers 2a and 2b will be described.

FIGS. 3A and 3B are perspective views partially illustrating the configuration of the electrode group before winding. FIG. 3A shows an example in which the thin portion 3a is provided on the surface of the positive electrode current collector 1 facing the outside of the electrode group 10. FIG. 3B shows an example in which the thin portion 3b is provided on the surface of the positive electrode current collector 1 facing the inside of the electrode group 10.

The thin portions 3a and 3b can be formed in a series of processes of forming the positive electrode material mixture layers on the surfaces of the positive electrode current collector 1. Specifically, in coating the surface of the positive electrode current collector 1 with positive electrode material mixture slurry by using a die coater, the pressure in a manifold of a die is adjusted to be negative, and the amount of the positive electrode material mixture slurry to be discharged from an end of the die is adjusted, thereby forming thin portions 3a and 3b thinner than the other portions of the positive electrode material mixture layers 2a and 2b. At this time, after adjusting the pressure in the manifold of the die to a negative value, the pressure is released so as to adjust the timing at which the positive electrode material mixture slurry is discharged again, thereby forming thin portions 3a and 3b having a uniform width along the direction perpendicular to the longitudinal direction of the positive electrode plate 4.

Thereafter, the positive electrode material mixture slurry is dried, and then the positive electrode material mixture layers 2a and 2b are pressed to thicknesses not smaller than those of the thin portions 3a and 3b. Subsequently, the positive electrode current collector 1 is subjected to a slitter process to have a predetermined width and a predetermined length, thereby obtaining a positive electrode plate 4 in the shape of a long strip.

The positive electrode material mixture slurry is obtained by mixing and dispersing a positive electrode active material, a conductive agent, and a binder in a dispersion medium, and the resultant mixture is kneaded, while being adjusted to have an optimum viscosity for application onto the positive electrode current collector 1.

Examples of the positive electrode active material include complex oxides such as lithium cobaltate, denatured lithium cobaltate (e.g., a substance in which aluminium or magnesium is dissolved in lithium cobaltate), lithium nickelate, denatured lithium nickelate (e.g., a substance in which nickel partially substitutes for cobalt), lithium manganate, and denatured lithium manganate.

As the conductive agent, carbon black such as acetylene black, Ketjen black, channel black, furnace black, lamp black, thermal black, and various types of graphite may be used solely or a two or more of these materials may be used in combination, for example.

Examples of the binder include polyvinylidene fluoride (PVdF), denatured polyvinylidene fluoride, polytetrafluoroethylene (PTFE), and rubber particle binder containing acrylate units. Acrylate monomer to which a reactive functional group is introduced or acrylate oligomer may be mixed in the binder.

The negative electrode plate 8 can be fabricated with a general technique as described below.

First, a negative electrode active material and a binder are mixed and dispersed in a dispersion medium, and the resultant mixture is kneaded while being adjusted to have an optimum viscosity for application onto the negative electrode current collector 5, thereby obtaining negative electrode mixture material slurry.

Examples of the negative electrode active material include various types of natural graphite, artificial graphite, silicon-based composite materials such as silicide, and various types of alloy composition materials.

Examples of the binder include polyvinylidene fluoride, and denatured polyvinylidene fluoride. To enhance lithium ion acceptability, styrene-butadiene rubber particles (SBR), denatured SBR, and cellulose-based resin such as carboxymethyl cellulose (CMC) are also preferably used or a material obtained by adding a small amount of such materials to the styrene-butadiene rubber particles or the denatured styrene-butadiene rubber particles is preferably used.

The obtained negative electrode mixture material slurry is applied onto the surface of the negative electrode current collector 5, is dried, and then is pressed to a predetermined thickness, thereby forming a negative electrode material mixture layer. Thereafter, the negative electrode material mixture layer is subjected to a slitter process to have a predetermined width and a predetermined length, thereby obtaining a negative electrode plate 8 in the shape of a long strip.

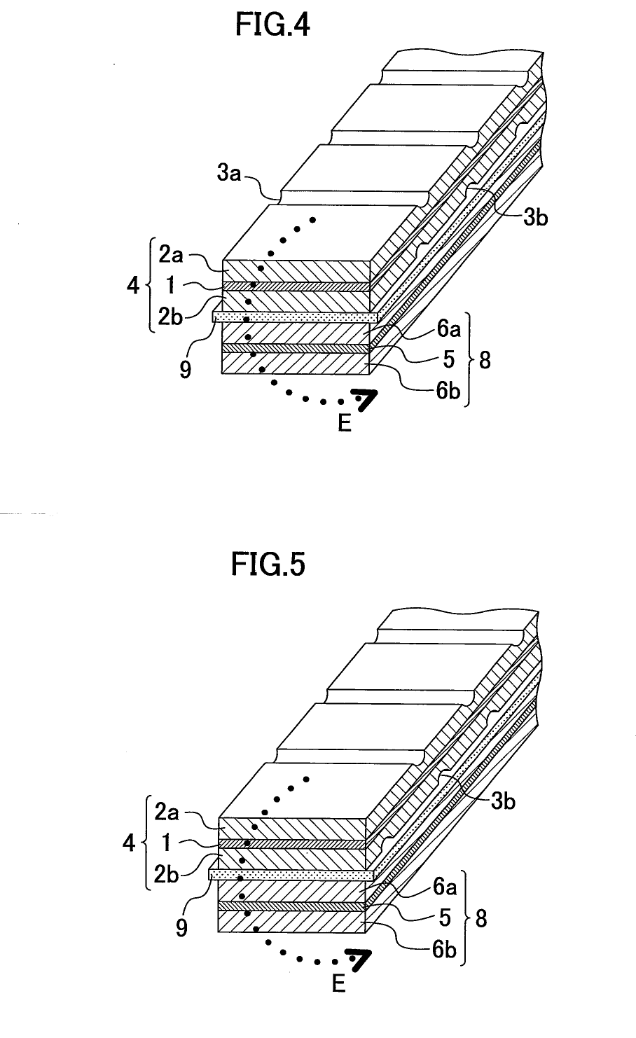

FIGS. 3A and 3B show the examples in which the thin portions 3a or 3b are provided on one of the surfaces of the positive electrode current collector 1. Alternatively, as illustrated in FIG. 4, the thin portions 3a and 3b may be provided on both surfaces of the positive electrode current collector 1. In this case, the thin portions 3a and 3b can be provided on both surfaces of the positive electrode current collector 1 with the technique described above.

As illustrated in FIG. 4, the thin portions 3a and 3b provided on both surfaces of the positive electrode current collector 1 have the same phase with respect to the longitudinal direction of the positive electrode plate 4. Alternatively, as illustrated in FIG. 5, the phases of the thin portions 3a and 3b may be shifted from each other.

In winding the positive electrode plate 4 and the negative electrode plate 8 with the separator 9 interposed therebetween to form an electrode group, a difference in curvature causes a tensile stress to be applied to an outer negative electrode material mixture layer 6a of the negative electrode plate 8, and also causes a compressive stress to an inner negative electrode material mixture layer 6b of the negative electrode plate 8.

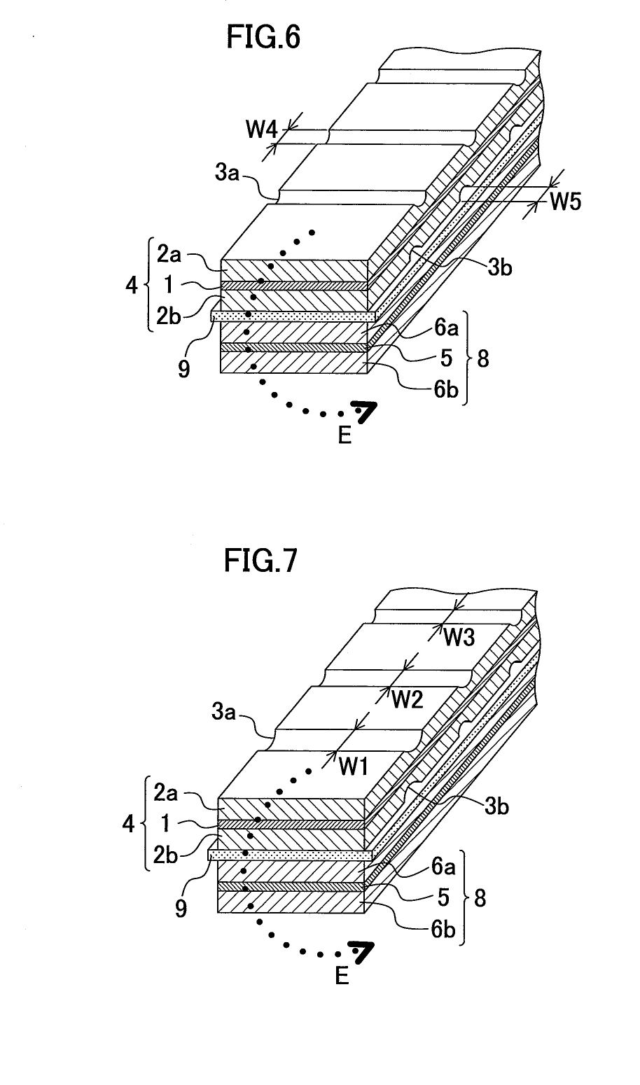

Under this situation, as illustrated in FIG. 6, the width W5 of the thin portion 3b formed in the inner positive electrode material mixture layer 2b of the positive electrode plate 4 facing the outer negative electrode material mixture layer 6a is made larger than the width W4 (i.e., W5>W4) of the thin portion 3a formed in the outer positive electrode material mixture layer 2a, thereby further reducing a stress to the positive electrode plate 4 induced by expansion and contraction of the negative electrode plate 8.

Further, in the electrode group formed by winding the positive electrode plate 4 and the negative electrode plate 8 with the separator 9 interposed therebetween, the curvatures of the electrode plates gradually decrease from the winding center to the winding end of the electrode group. Accordingly, the tensile stress applied to the outer negative electrode material mixture layer 6a and the compressive stress applied to the inner negative electrode material mixture layer 6b described above gradually decrease.

In view of this phenomenon, as illustrated in FIG. 7, he thin portions 3a and 3b are formed such that the widths W1, W2, and W3 of the thin portions 3a and 3b decrease in this order (i.e., W1>W2>W3) from the winding center to the winding end of the electrode group. Accordingly, the stress to the positive electrode plate 4 induced by expansion and contraction of the negative electrode plate 8 can be reduced, and at the same time, the total amount of the positive electrode material mixture layers 2a and 2b can be increased, thereby reducing the amount of decrease in battery capacity caused by providing the thin portions 3a and 3b.

Advantages obtained by adjusting the widths of the thin portions 3a and 3b as illustrated in FIGS. 6 and 7 can also be obtained by adjusting the distances between the thin portions 3a and 3b arranged along the longitudinal direction of the positive electrode plate 4.

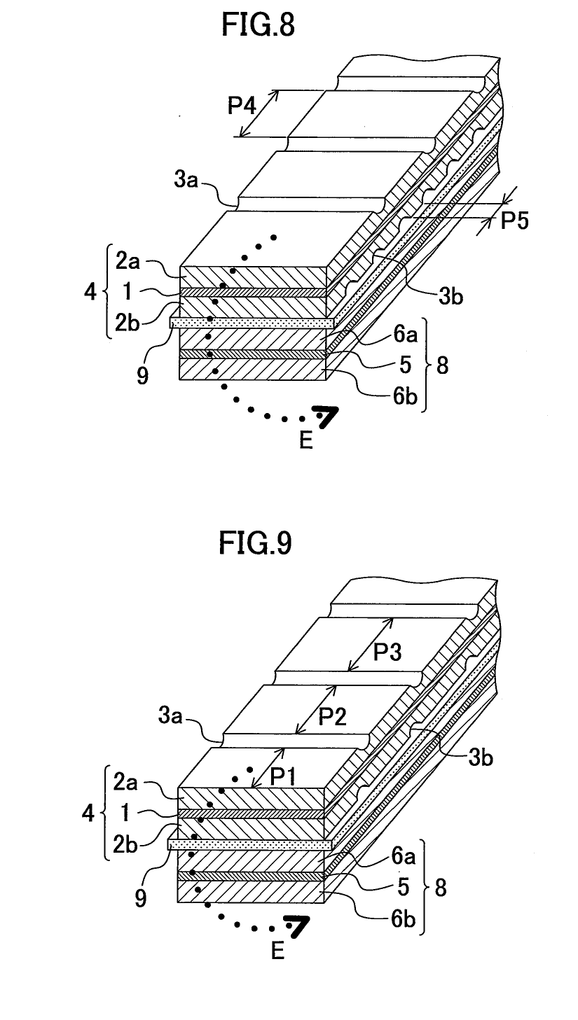

Specifically, as illustrated in FIG. 8, the distance P5 between the thin portions 3b formed in the inner electrode material mixture layer 2b in the electrode group is shorter than the distance P4 (i.e., P5<P4) between the thin portions 3a formed in the outer positive electrode material mixture layer 2a in the electrode group, thereby obtaining similar advantages to those obtained by the configuration (i.e., W5>W4) of the thin portions 3a and 3b illustrated in FIG. 6.

In addition, as illustrated in FIG. 9, a plurality of thin portions 3a and 3b formed in the positive electrode material mixture layers 2a and 2b may be formed such that the distances P1, P2, and P3 between the thin portions gradually increase in this order (i.e., P1<P2<P3) from the winding center to the winding end of the electrode group, thereby obtaining similar advantages to those obtained by the configuration (i.e., W1>W2>W3) of the thin portions 3a and 3b illustrated in FIG. 7.

### Second Embodiment

In the first embodiment, the thin portions 3a and 3b are provided in parts of the positive electrode material mixture layers 2a and 2b so that a stress to the positive electrode plate 4 induced by expansion and contraction of the negative electrode plate 8 is reduced. On the other hand, in the second embodiment, a portion having a low density of an active material (hereinafter referred to as a low-density active material portion) is provided in parts of the positive electrode material mixture layers 2a and 2b, thereby obtaining similar advantages to those obtained in the first embodiment.

Specifically, since expansion and contraction of the negative electrode plate 8 are caused by insertion and extraction of lithium in/from the negative electrode active material layer, the presence of low-density active material portions are provided in parts of the positive electrode material mixture layers 2a and 2b of the positive electrode plate 4 facing the negative electrode plate 8 can locally reduce the amount of insertion and extraction of lithium in/from the negative electrode active material layer. In this manner, expansion and contraction of the negative electrode plate 8 can be reduced, thereby reducing a stress to the positive electrode plate 4 induced by expansion and contraction of the negative electrode plate 8.

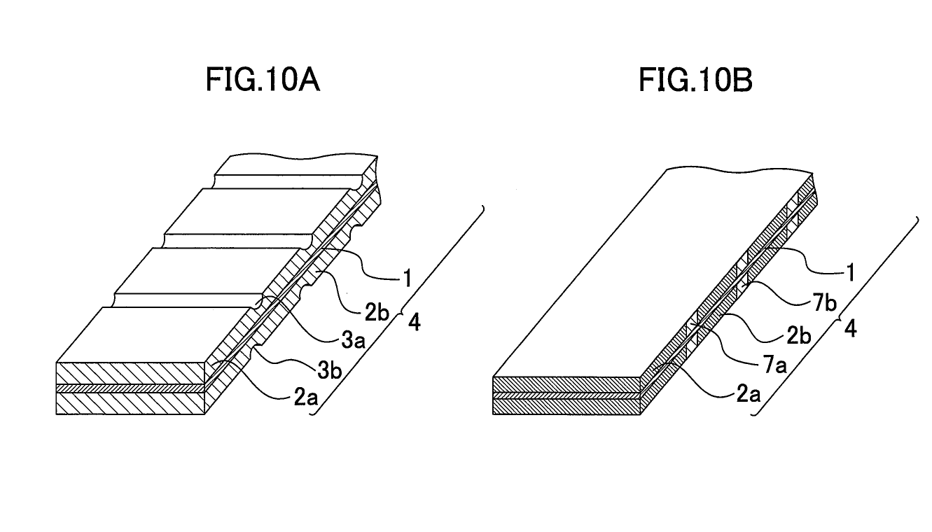

FIGS. 10A and 10B are perspective views showing a method for forming a positive electrode plate 4 according to this embodiment.

First, as illustrated in FIG. 10A, at least one thin portion 3a and at least one thin portion 3b are respectively formed in positive electrode material mixture layers 2a and 2b to extend perpendicularly to the longitudinal direction of a positive electrode current collector 1. These thin portions 3a and 3b can be formed by intermittent coating described in the first embodiment.

Next, as illustrated in FIG. 10B, the positive electrode material mixture layers 2a and 2b are pressed to thicknesses smaller than those of the thin portions 3a and 3b. In this manner, the density of a positive electrode active material in portions where the thin portions 3a and 3b are formed is lower than that of the positive electrode active material in the other portion. Accordingly, low-density active material portions 7a and 7b are formed in parts of the positive electrode material mixture layers 2a and 2b.

This embodiment differs from the first embodiment in that the positive electrode material mixture layers 2a and 2b are pressed to thicknesses not smaller than those of the thin portions 3a and 3b in the first embodiment, whereas the positive electrode material mixture layers 2a and 2b are pressed to thicknesses smaller than those of the thin portions 3a and 3b in the second embodiment. Accordingly, in the second embodiment, the surface of each of the positive electrode material mixture layers 2a and 2b is plane. Therefore, in this embodiment, the diameter of an electrode group formed by winding the positive electrode plate 4 and a negative electrode plate 8 with a separator 9 interposed therebetween can be smaller than that of the electrode group of the first embodiment.

The number and the shape (e.g., thickness, width, and pitch) of the low-density active material portions 7a and 7b provided in parts of the positive electrode material mixture layers 2a and 2b are not specifically limited, and may be determined according to the degree of expansion and contraction of the negative electrode plate 8 to be used.

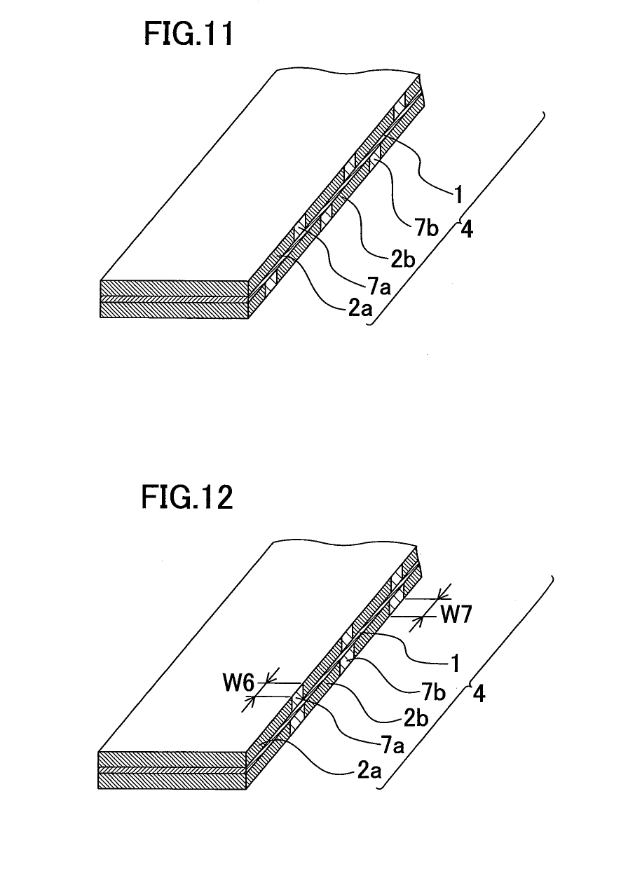

Referring now to FIGS. 11-15, various examples of the low-density active material portions 7a and 7b provided in the positive electrode material mixture layers 2a and 2b will be described.

FIG. 11 corresponds to FIG. 5 for the first embodiment. In FIG. 11, the phases of the low-density active material portions 7a and 7b provided on both surfaces of the positive electrode current collector 1 are shifted from each other along the longitudinal direction of the positive electrode plate 4. With this configuration, the amount of lithium inserted and extracted in/from the negative electrode active material layers facing the low-density active material portions 7a and 7b differs between both surfaces of the negative electrode plate 8, thereby effectively reducing expansion and contraction of the negative electrode plate 8 in the entire electrode group. Consequently, a stress to the positive electrode plate 4 induced by expansion and contraction of the negative electrode plate 8 can be further reduced.

FIG. 12 corresponds to FIG. 6 for the first embodiment. In FIG. 12, the width W7 of the low-density active material portion 7b provided on the inner positive electrode material mixture layer 2b of the positive electrode plate 4 is larger than the width W6 (i.e., W7>W6) of the low-density active material portion 7a provided the outer positive electrode material mixture layer 2a. In this manner, a stress to the positive electrode plate 4 induced by expansion and contraction of the negative electrode plate 8 can be further reduced.

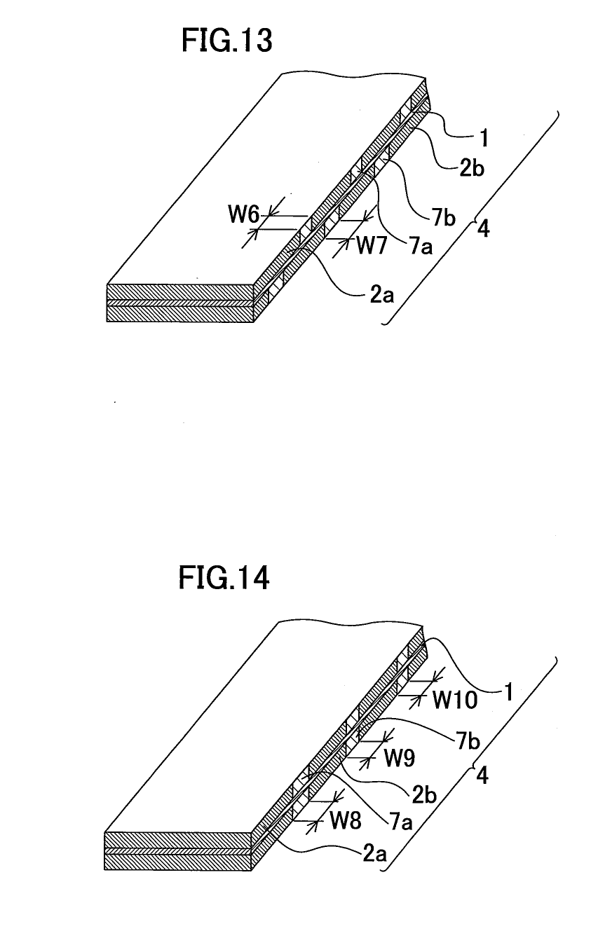

Alternatively, as illustrated in FIG. 13, the phases of the low-density active material portions 7a and 7b provided on both surfaces of the positive electrode current collector 1 may be shifted from each other along the longitudinal direction of the positive electrode plate 4.

FIG. 14 corresponds to FIG. 7 for the first embodiment. The widths W8, W9, and W10 of the low-density active material portions 7a and 7b gradually decrease in this order (i.e., W8>W9>W10) from the winding center to the winding end of the electrode group. Accordingly, a stress to the positive electrode plate 4 induced by expansion and contraction of the negative electrode plate 8 can be reduced, and at the same time, the total amount of the positive electrode material mixture layers 2a and 2b can be increased, thereby reducing the amount of decrease in battery capacity caused by providing the low-density active material portions 7a and 7b.

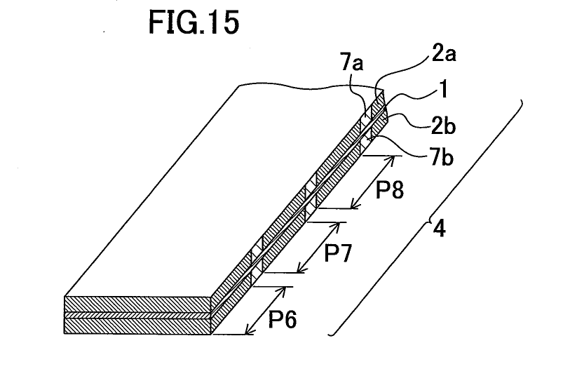

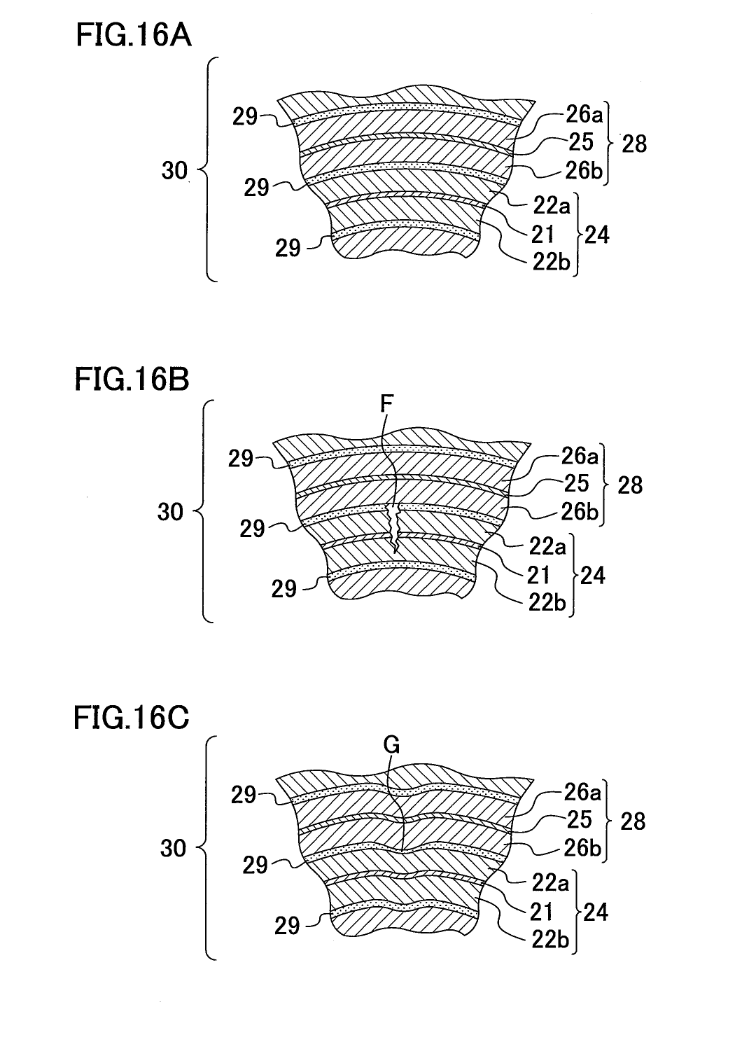

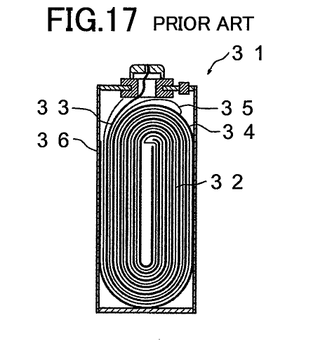

FIG. 15 corresponds to FIG. 9 for the first embodiment. In FIG. 15, the distances P6, P7, and P8 between the low-density active material portions 7a and 7b formed in the positive electrode material mixture layers 2a and 2b gradually increase in this order (i.e., P6<P7<P8) from the winding center to the winding end of the electrode group. Accordingly, similar advantages to those obtained by the configuration (i.e., W8>W9>W10) of the low-density active material portions 7a and 7b illustrated in FIG. 14 can be obtained.

It should be recognized that the foregoing description has been set forth for purposes of preferred embodiments of the present invention, and is not intended to limit the scope of the invention, and various changes and modifications may be made. For example, in the above embodiments, the electrode group is formed by winding the positive electrode plate and the negative electrode plate with the separator interposed therebetween. Alternatively, the electrode group may be formed by stacking the positive electrode plate and the negative electrode plate with the separator interposed therebetween.

### EXAMPLES

Configurations and advantages of the present invention will be further described hereinafter based on examples. However, it should be noted that the present invention is not limited to the following examples.

### First Example

First, 100 parts, by weight, of lithium cobaltate as an active material, 2 parts, by weight, of acetylene black as a conductive agent, and 2 parts, by weight, of polyvinylidene fluoride as a binder were stirred and kneaded with an appropriate amount of n-methyl-2-pyrrolidone, thereby producing positive electrode material mixture slurry.

Next, as illustrated in FIG. 3A, the positive electrode material mixture slurry was applied onto one surface, extending along the longitudinal direction, of a positive electrode current collector 1 made of aluminium foil (with an Al purity of 99.85%) having a thickness of 15 μm such that thin portions 3a with a width of 5 mm were formed at a pitch on this surface. Then, the resultant structure was dried. In this manner, a positive electrode plate 4 in which each of positive electrode material mixture layers 2a and 2b respectively formed on both surfaces of the positive electrode plate 4 had a thickness of 100 μm and a thin portion 3a of the positive electrode material mixture layer 2a had a thickness of 65 μm, was obtained.

Thereafter, the positive electrode plate 4 was pressed to a total thickness of 165 μm, thereby allowing each of the positive electrode material mixture layers 2a and 2b to have a thickness of 75 μm. Subsequently, the resultant positive electrode plate 4 was subjected to a slitter process to have a predetermined width, thereby obtaining a positive electrode plate 4.

On the other hand, 100 parts, by weight, of artificial graphite as a negative electrode active material, 2.5 parts, by weight, (1 part, by weight, in terms of the solid content of a binder) of a styrene-butadiene rubber particle dispersing element (solid content: 40 parts, by weight) as a binder, and 1 part, by weight, of carboxymethyl cellulose as a thickener were stirred with an appropriate amount of water, thereby producing negative electrode material mixture slurry.

Next, the negative electrode mixture material slurry was applied onto a negative electrode current collector 5 made of copper foil (with a Cu purity of 99.9%) having a thickness of 10 μm, and the resultant structure was dried. In this manner, a negative electrode plate 8 in which negative electrode material mixture layers 6a and 6b each had a thickness of 110 μm was obtained. Subsequently, this negative electrode plate 8 was pressed to have a total thickness of 180 μm, and then was subjected to a slitter process to have a predetermined width, thereby obtaining a negative electrode plate 8.

The positive electrode plate 4 and negative electrode plate 8 thus obtained were wound in a spiral with a separator 9 of a polyethylene microporous film with a thickness of 20 μm interposed therebetween, thereby forming an electrode group 10. This electrode group 10 was housed in a closed-end cylindrical battery case 11, and then a nonaqueous electrolyte in which 1 M of LiPF₆ and 3 parts, by weight, of VC were dissolved in a predetermined amount of an EC, DMC, and MEC mixture solvent was poured in this battery case 11. Thereafter, an opening of the battery case 11 was sealed with the sealing plate 15, thereby obtaining a cylindrical lithium ion secondary battery 17 illustrated in FIG. 1.

### Second Example

As illustrated in FIG. 4, a cylindrical lithium ion secondary battery was fabricated in the same manner as that in the first example except for that thin portions 3a and 3b each having a width of 5 mm and a thickness of 65 μm were formed at a pitch on both surfaces of the positive electrode current collector 1 to have the same phase.

### Third Example

As illustrated in FIG. 5, a cylindrical lithium ion secondary battery was fabricated in the same manner as that in the first example except for that thin portions 3a and 3b each having a width of 5 mm and a thickness of 65 μm were formed at a pitch on both surfaces of the positive electrode current collector 1 to have different phases.

### Fourth Example

As illustrated in FIG. 6, a cylindrical lithium ion secondary battery was fabricated in the same manner as that in the first example except for that thin portions 3a each having a width of 5 mm and a thickness of 65 μm were formed on the front surface of the positive electrode current collector 1, thin portions 3b each having a width of 6 mm and a thickness of 65 μm were formed on the back surface of the positive electrode current collector 1, and the thin portions 3a and 3b were formed at a pitch and had the same phase.

### Fifth Example

As illustrated in FIG. 7, a cylindrical lithium ion secondary battery was fabricated in the same manner as that in the first example except for that the widths of thin portions 3a and 3b each having a thickness of 65 μm and formed on both surfaces of the positive electrode current collector 1 gradually decreased to 5 mm, 4.5 mm, and 4.0 mm in this order from the winding center to the winding end of the electrode group.

### Sixth Example

As illustrated in FIG. 8, a cylindrical lithium ion secondary battery was fabricated in the same manner as that in the first example except for that thin portions 3a each having a width of 5 mm and a thickness of 65 μm were formed at a 30-mm pitch on the front surface of the positive electrode current collector 1 and thin portions 3b each having a width of 5 mm and a thickness of 65 μm were formed at a 15-mm pitch on the back surface of the positive electrode current collector 1.

### Seventh Example

As illustrated in FIG. 9, a cylindrical lithium ion secondary battery was fabricated in the same manner as that in the first example except for that the distance between each adjacent ones of thin portions 3a and 3b having a thickness of 65 μm and formed on both surfaces of the positive electrode current collector 1 gradually increased to 20 mm, 30 mm, and 40 mm in this order from the winding center to the winding end of the electrode group.

### Eighth Example

As illustrated in FIG. 10A, in the same manner as that in the first example, thin portions 3a and 3b each having a width of 5 mm and a thickness of 75 μm were formed at a pitch on both surfaces of the positive electrode current collector 1 to have the same phase. Thereafter, the positive electrode material mixture layers 2a and 2b were pressed to a thickness of 75 μm, thereby forming low-density active material portions 7a and 7b having a width of 5 mm, a thickness of 75 μm, the same phase, and the same pitch. Then, in the same manner as that in the first example, a cylindrical lithium ion secondary battery as illustrated in FIG. 1 was fabricated.

### Ninth Example

As illustrated in FIG. 11, a cylindrical lithium ion secondary battery was fabricated in the same manner as that in the eighth example except for that low-density active material portions 7a and 7b each having a width of 5 mm and a thickness of 75 μm were formed at a pitch on both surfaces of the positive electrode current collector 1 to have different phases.

### Tenth Example

As illustrated in FIG. 12, a cylindrical lithium ion secondary battery was fabricated in the same manner as that in the eighth example except for that a low-density active material portion 7a with a width of 3 mm and a thickness of 75 μm was formed on the front surface of the positive electrode current collector 1, a low-density active material portion 7b with a width of 5 mm and a thickness of 75 μm was formed on the back surface of the positive electrode current collector 1, and the low-density active material portions 7a and 7b were formed at a pitch and had the same phase.

### Eleventh Example

As illustrated in FIG. 13, a cylindrical lithium ion secondary battery was fabricated in the same manner as that in the eighth example except for that a low-density active material portion 7a with a width of 3 mm and a thickness of 75 μm was formed on the front surface of the positive electrode current collector 1, a low-density active material portion 7b with a width of 5 mm and a thickness of 75 μm was formed on the back surface of the positive electrode current collector 1, and the low-density active material portions 7a and 7b were formed at a pitch and had phases which are ½ shifted from each other.

### Twelfth Example

As illustrated in FIG. 14, a cylindrical lithium ion secondary battery was fabricated in the same manner as that in the eighth example except for that low-density active material portions 7a and 7b each having a thickness of 75 μm were formed on both surfaces of the positive electrode current collector 1, and the width of the low-density active material portions 7a and 7b gradually decreased to 5 mm, 4.5 mm, and 4.0 mm in this order from the winding center to the winding end of the electrode group.

### Thirteenth Example

As illustrated in FIG. 15, a cylindrical lithium ion secondary battery was fabricated in the same manner as that in the eighth example except for that low-density active material portions 7a and 7b each having a thickness of 75 μm were formed on both surfaces of the positive electrode current collector 1, and the distance between each adjacent ones of the low-density active material portions 7a and 7b gradually increased to 20 mm, 30 mm, and 40 mm in this order from the winding center to the winding end of the electrode group.

In each of the first to thirteenth examples, 100 lithium ion secondary batteries 17 were fabricated, and 500 cycles of charging and discharging were performed. However, no cycle deterioration occurred. Further, 20 batteries were taken from the 100 lithium ion secondary batteries 17 subjected to 500 cycles of charging and discharging, and electrode groups 10 of these 20 batteries were disassembled. Then, no failures such as lithium precipitation, breakage and buckling of electrode palates, and peeling-off of electrode mixture layers were observed.

### INDUSTRIAL APPLICABILITY

The present invention is useful for batteries for use as power sources of mobile equipment which needs to have its capacity increased with an increase in the number of functions of electronic equipment and communication equipment.

### DESCRIPTION OF REFERENCE CHARACTERS

1 positive electrode current collector
2a, 2b positive electrode material mixture layer
3a, 3b thin portion
4 positive electrode plate
5 negative electrode current collector
6a, 6b negative electrode material mixture layer
7a, 7b low-density active material portion
8 negative electrode plate
9 separator
10 electrode group
11 battery case
12 insulating plate
13 negative electrode lead
14 positive electrode lead
15 sealing plate
16 gasket
17 lithium ion secondary battery

1. A nonaqueous electrolyte secondary battery, comprising an electrode group in which a positive electrode plate including a positive electrode current collector and a positive electrode material mixture layer formed on the positive electrode current collector, and a negative electrode plate including a negative electrode current collector and a negative electrode material mixture layer formed on the negative electrode current collector, are wound or stacked with a separator interposed therebetween, wherein
the positive electrode material mixture layer has at least one thin portion extending perpendicularly to a longitudinal direction of the positive electrode plate.

2. The nonaqueous electrolyte secondary battery of claim 1, wherein the thin portion of the positive electrode material mixture layer is located on at least an inner surface of the positive electrode current collector.

3. The nonaqueous electrolyte secondary battery of claim 1, wherein the thin portion of the positive electrode material mixture layer is located on each surface of the positive electrode current collector, and
the thin portion located on an inner surface of the positive electrode current collector and the thin portion located on an outer surface of the positive electrode current collector have phases which are shifted from each other.

4. The nonaqueous electrolyte secondary battery of claim 1, wherein the thin portion of the positive electrode material mixture layer is located on each surface of the positive electrode current collector, and
the thin portion located on an inner surface of the positive electrode current collector has a width lager than a width of the thin portion located on an outer surface of the positive electrode current collector.

5. The nonaqueous electrolyte secondary battery of claim 1, wherein the positive electrode material mixture layer includes multiple ones of the at least one thin portion, and
widths of the thin portions decrease from a winding center to a winding end of the electrode group.

6. The nonaqueous electrolyte secondary battery of claim 1, wherein the positive electrode material mixture layer includes multiple ones of the at least one thin portion,
the positive electrode material mixture layer is formed on each surface of the positive electrode current collector, and
a distance between each adjacent ones of the thin portions located on an inner surface of the positive electrode current collector is smaller than a distance between each adjacent ones of the thin portions located on an outer surface of the positive electrode current collector.

7. The nonaqueous electrolyte secondary battery of claim 1, wherein the positive electrode material mixture layer includes multiple ones of the at least one thin portion, and
a distance between each adjacent ones of the thin portions increases from a winding center to a winding end of the electrode group.

8. The nonaqueous electrolyte secondary battery of claim 1, wherein the thin portion of the positive electrode material mixture layer is located at least at a position where the positive electrode material mixture layer has a small radius of curvature near a winding center of the electrode group.

9. The nonaqueous electrolyte secondary battery of claim 1, wherein instead of the thin portion, the positive electrode material mixture layer has at least one low-density active material portion extending perpendicularly to the longitudinal direction of the positive electrode plate.

10. The nonaqueous electrolyte secondary battery of claim 9, wherein the low-density active material portion of the positive electrode material mixture layer is located on at least an inner surface of the positive electrode current collector.

11. The nonaqueous electrolyte secondary battery of claim 9, wherein the low-density active material portion of the positive electrode material mixture layer is located on each surface of the positive electrode current collector, and
the low-density active material portion located on an inner surface of the positive electrode current collector and the low-density active material portion located on an outer surface of the positive electrode current collector have phases which are shifted from each other.

12. The nonaqueous electrolyte secondary battery of claim 9, wherein the low-density active material portion of the positive electrode material mixture layer is located on each surface of the positive electrode current collector, and
the low-density active material portion located on an inner surface of the positive electrode current collector has a width lager than a width of the low-density active material portion located on an outer surface of the positive electrode current collector.

13. The nonaqueous electrolyte secondary battery of claim 9, wherein the positive electrode material mixture layer includes multiple ones of the at least one low-density active material portion, and
widths of the low-density active material portions decrease from a winding center to a winding end of the electrode group.

14. The nonaqueous electrolyte secondary battery of claim 9, wherein the positive electrode material mixture layer includes multiple ones of the at least one low-density active material portion,
a distance between each adjacent ones of the low-density active material portions increases from a winding center to a winding end of the electrode group.

15. A nonaqueous electrolyte secondary battery of claim 9, wherein the low-density active material portion of the positive electrode material mixture layer is located at least at a position where the positive electrode material mixture layer has a small radius of curvature near a winding center of the electrode group.
